(19) United States
(12) Patent Application Publication
(10) Pub. No.: US 2005/0046417 A1
(43) Pub. Date: Mar. 3, 2005

(54) ULTRA POWER-SAVING TYPE METER FOR CONVERTING MEASURED VALUE INTO DIGITAL SIGNAL

(75) Inventors: Eul-Jung Hwang, Jinju city (KR); Sung-Ju Jang, Jinju city (KR); Il-Gwon Jeong, Sacheon city (KR)

Correspondence Address: Frank Chau;F. CHAU & ASSOCIATES, LLP, Suite 501, 1900 Hempstead Turnpike, East Meadow, NY, 11554, US

(73) Assignee: Chaos Co., Ltd.

(21) Appl. No.: 10/436,171

(22) Filed: May 12, 2003

(30) Foreign Application Priority Data
Sep. 5, 2002 (KR) 2002-53604
Nov. 18, 2002 (KR) 2002-71469
Feb. 13, 2003 (KR) 2003-09202

(51) Int. Cl. G01B 7/30

(52) U.S. Cl. 324/207.25

(57) ABSTRACT

Disclosed is a meter for converting a measured analog value into a digital signal, and more particularly an ultra power-saving type meter having the function of converting a value measured into a digital signal, in which when a used amount measured by an analog meter reaches a predetermined value, the value is detected and converted into a digital signal, and then transmitted to a remote device using the minimum electric power, thereby reducing the power consumption rate and allowing the meter to be used for a long period of time without replacement of its battery for providing operating power to the meter. The ultra power-saving type meter comprises a link member (L), a reader switch (S), and a restriction part (h). The link member (L) provided with a magnet is hinged to a pointer needle of the meter, which is rotated according to the used amount of a flow. The link member (L) is eccentric from a central axis of rotation of the pointer needle. The reader switch (S) serves as a sensor for recognizing one rotation of the pointer needle as a digital signal by means of the magnet of the link member (L). The restriction part (h) temporarily restricts an entry of the link member into a sensing range of the reader switch (S), and then suddenly triggers the link member (L). The restriction part (h) is located on a designated position outside of the sensing range. The magnet of the link member rapidly passes through the sensing range of the reader switch regardless of a rotational speed of the pointer needle of the meter.

### TECHNICAL FIELD

The present invention relates to a meter for converting a value measured by an analog meter into a digital signal, and more particularly to an ultra power-saving type meter having the function of converting a measured value into a digital signal, in which when the amount of consumption measured by an analog meter comes to a predetermined value, the value is detected and converted into a digital signal, and then transmitted to a remote device using the minimum of electric power, thereby reducing the power consumption rate and allowing the meter to be used for a long period of time without replacement of its battery for providing operating power to the meter.

### BACKGROUND ART

As well known to those skilled in the art, the amount of consumption of water, electricity, gas, or etc. is measured and cumulated. When a predetermined period elapses, the measured cumulative amount of consumption is read out, and then a fee is assessed and imposed on a user according to the read-out value.

In order to impose fees on users, a monthly amount of consumption of each user must be individually read out. Such a read-out system depends on human labor. That is, a meter reader makes a round of users' homes so as to read out the amount of consumption of a meter of each user.

Such a manpower-based read-out system cannot be implemented during user's absence. Further, even during user's presence, this manpower-based read-out system exposes the users to risks of various crimes. Therefore, with this manpower-based read-out system, it is difficult to safely and precisely read the amount of consumption of the users' meters.

In order to solve the above-described problems, various remote systems and/or methods for reading the cumulative measured value of each user have been proposed.

However, most of the remote read-out systems require comparatively high-cost equipment, thereby not being practically used.

Therefore, in order to settle such a practical use problem, the applicant of the present invention has already described a “remote read-out system”, in Korean Utility Model Reg. No. 228613.

In accordance with the above-disclosed remote read-out system, a permanent magnet is installed on the upper end of a rotary axis rotating according to the flow rate of a meter. Coils are installed on the upper part of the meter. Here, the permanent magnet and the coils interact with each other, thereby generating electricity. The generated electricity is used as power for operating circuitry of the meter. Simultaneously, the waveform of the generated electricity is analyzed, and thus the cumulative value of the flow rate is detected by an analog-to-digital converter (A/D converter). The detected value is remotely transmitted to a relevant agency.

Since the remote read-out system of the above Korean Utility Model eliminates the inconvenience of the conventional manpower read-out system, it is advantageous in terms of the utility and convenience. However, this remote read-out system is complicated in the configuration of its circuitry, thereby increasing its production cost.

Various methods for digitalizing the measured value of the meter have been proposed. However, the above-proposed methods limit the configuration of circuitry for digitalizing the measured value and a power supply unit for providing operating power to the circuitry.

Since a water meter is laid underground separately from electric wiring, it is difficult to connect it to a utility power supply. Therefore, preferably, the water meter is operated by a battery.

However, although the water meter is operated by the conventional battery, since the water meter has a high power consumption rate, the battery of the meter must be frequently replaced with a new one, thus not being practically used.

In case that the meter is stopped when a pointer needle of the meter reaches a designated point where a detection sensor is located, the sensor is continuously maintained in an operating state. Then, circuitry relating to the sensor is continuously operated and power is unnecessarily consumed. It is impossible to use the meter provided with the battery as a power supply source for providing limited electricity for a long period of time.

Therefore, there is required a meter employing a battery as a power supply source, which is continuously and substantially used for at least approximately 10 years without replacing the battery with a new one.

### SUMMARY OF THE INVENTION

Therefore, the present invention has been made in view of the above problems, and it is an object of the present invention to provide an ultra power-saving type meter having the function of converting a measured value into a digital signal, being additionally combined with a conventional meter, in which a reader switch for recognizing one rotation of a pointer needle as a digital signal is installed, a link shaft rapidly passes through the sensing range of the reader switch regardless of a rotational speed of the pointer needle so as to allow the reader switch to rapidly and precisely sense the rotation of the pointer needle, and power is consumed only for a short sensing time of the reader switch so as to allow the meter to be used for a long period of time without replacing its battery with a new one.

It is another object of the present invention to provide an ultra power-saving type meter having the function of converting a value measured by the meter into a digital signal, in which a link shaft rapidly passes through the sensing range of a reader switch serving as a sensor regardless of a rotational speed of a pointer needle, thereby shortening the sensing time of the reader switch and thus preventing error and malfunction in the sensing step of the reader switch.

In accordance with the present invention, the above and other objects can be accomplished by the provision of an ultra power-saving type meter for converting a measured value into a digital signal, comprising: a link member provided with a magnet, and hinged to a pointer needle of the meter rotating according to the amount of consumption of a flow so as to be eccentric from a central axis of rotation of the pointer needle; a reader switch serving as a sensor for recognizing one rotation of the pointer needle as a digital signal by means of the magnet of the link member; and a restriction part for temporarily restricting an entry of the link member into a sensing range of the reader switch and then suddenly triggering the link member, being located on a designated position outside of the sensing range of the reader switch, wherein the magnet of the link member rapidly passes through the sensing range of the reader switch regardless of a rotational speed of the pointer needle of the meter.

Preferably, since the magnet of the link member rapidly passes through the sensing range of the reader switch, and the link member is located outside of the sensing range of the reader switch, power for operating the reader switch is consumed only at the sensing moment of the reader switch.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a principle of converting a measured value of a meter into a digital signal in accordance with the present invention;

FIGS. 2a, 2b is a schematic view of a meter in accordance with one embodiment of the present invention;

FIGS. 3a to 3c schematically show the configurations of a pointer needle and a link member of the meter of FIG. 2, specifically:

FIG. 3a is an exploded perspective view of the pointer needle and the link member;

FIG. 3b is an assembled perspective view of the pointer needle and the link member; and

FIG. 3c is a plan view illustrating an operation of a link shaft of the link member connected to the pointer needle;

FIGS. 4a to 4f respectively show rotational steps of the pointer needle of the meter of FIG. 2; and

FIG. 5 is a schematic view of a meter in accordance with another embodiment of the present invention.

### DETAILED DESCRIPTION OF THE PREFERRED EMBODIMENTS

Now, preferred embodiments of the present invention will be described in detail with reference to the annexed drawings.

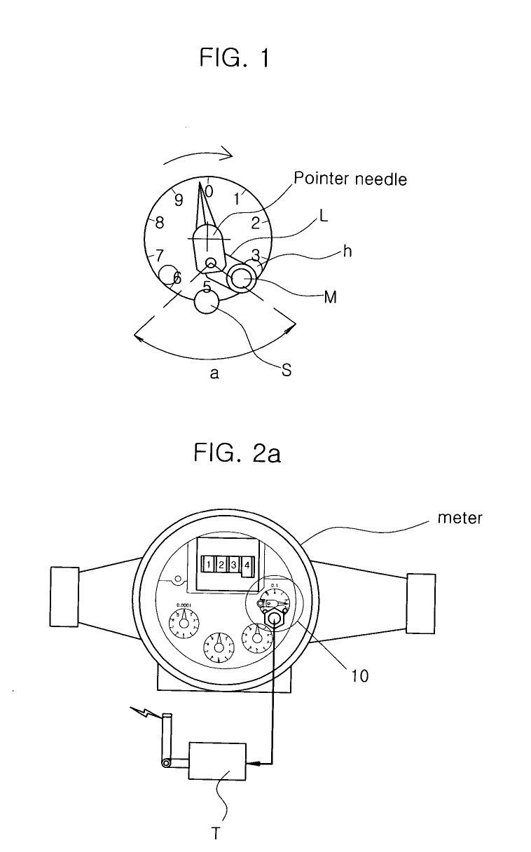

As shown in FIG. 1, an ultra power-saving meter of the present invention comprises a link member (L), a reader switch (S), and a restriction part (h). The link member (L) is provided with a magnet (M) and hinged to a pointer needle of a needle part, rotating according to the amount of consumption of a flow. The link member (L) is eccentric from a central axis of rotation of the pointer needle. The reader switch (S) serving as a sensor recognizes one rotation of the pointer needle as a digital signal by means of the magnet (M) of the link member (L). The restriction part (h) temporarily restricts an entry of the link member (L) into a sensing range of the reader switch (S), and then suddenly triggers the link member (L) into the sensing range. The restriction part (h) is located on a designated position outside of the sensing range (a). Thereby, the magnet (M) of the link member (L) rapidly passes through the sensing range (a) of the reader switch (S) regardless of a rotational speed of the pointer needle of the meter.

The restriction part (h) may be a magnet or a mechanical stopper, and its detailed description is described, as follows.

Hereinafter, in accordance with one preferred embodiment of the present invention, the restriction part (h) includes magnets. The magnets of the restriction part (h) interact with the magnet (M) of the link shaft by virtue of the repulsive and attractive forces acting between polarities of the magnets.

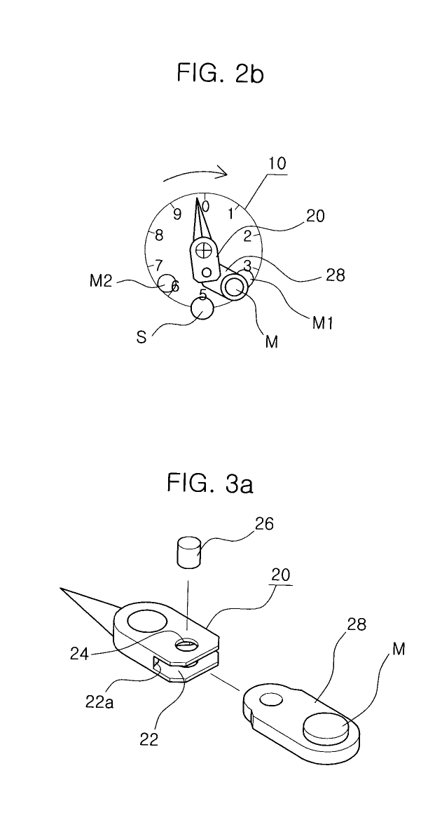

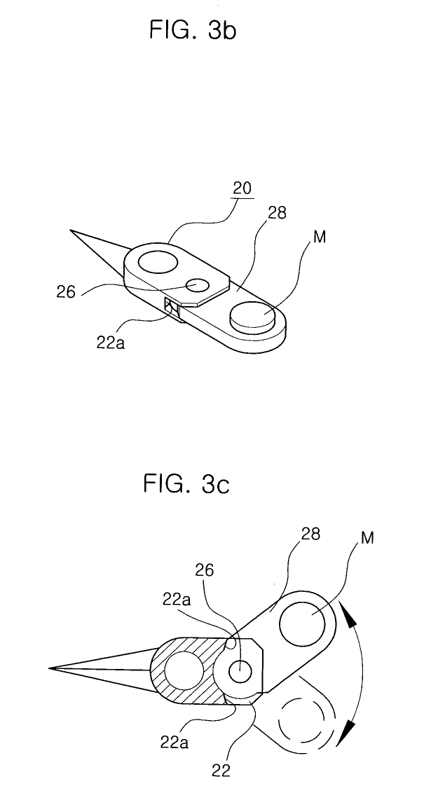

FIG. 2 is a schematic view of the meter of the present invention, which is additionally combined with a conventional water meter.

Plural meters for measuring the amount of consumption of a water flow are installed on the combined water meter.

Preferably, the ultra power-saving type meter of the present invention is used as a meter for measuring the smallest unit of the amount of consumption of the water flow (in FIG. 2, the pointer needle within the meter is rotated one time per 1 ton of the amount of water consumption). The meter for measuring the smallest unit of the amount of water consumption has a comparatively high rotational speed of its pointer needle. Minimum power is consumed to rotate the pointer needle of the meter for measuring the smallest unit of the amount of water consumption, and simultaneously the amount of consumption is precisely measured by the meter. Therefore, the meter for measuring the smallest unit of the amount of water consumption is advantageous in cumulative metering.

The ultra power-saving type meter 10 in accordance with this embodiment of the present invention comprises a rotatable pointer needle 20, and a dial plate 12. The pointer needle 20 includes one pointed end and the other end being opposite to the pointed end, a slot 22, and a pin hole 24. The slot 22 is formed through the other end of the pointer needle 20 so that a link shaft 28 of the link member (L) provided with the magnet (M) laid in the end of the link shaft 28 is rotatably connected to the pointer needle 20 by a fixing pin 26.

The restriction part (h) includes a first magnet (M1) and a second magnet (M2). The first magnet (M1) is attached on the dial plate 12 at a designated position prior to the start of the sensing range (a). A surface of the first magnet (M1) has the same polarity as that of the opposite surface of the magnet (M) of the link shaft 28. The second magnet (M2) is attached on the dial plate at another designated position after the end of the sensing range (a). A surface of the second magnet (M2) has the reverse polarity of that of the opposite surface of the magnet (M) of the link shaft 28.

The reader switch (S) for sensing the passing of the magnet (M) of the link shaft 28 is located at an approximately central position between the first and second magnets (M1 and M2) formed on the dial plate 12. Each position of the first and second magnets (M1 and M2) interacting with the magnet (M) of the link shaft 28 is located outside of the sensing range (a) of the reader switch (S) on the dial plate 12.

The operation and function of the ultra power-saving type meter of this embodiment of the present invention are described, as follows.

Since link shaft 28 is rotatably connected to one end of the pointer needle 20 so as to be eccentric from the central rotary axis of the pointer needle 20, the link shaft 28 is rotatable from the pointer needle 20.

The range of the rotating angle of the link shaft 28 is restricted by ridges 22a formed on both ends of the slot 22.

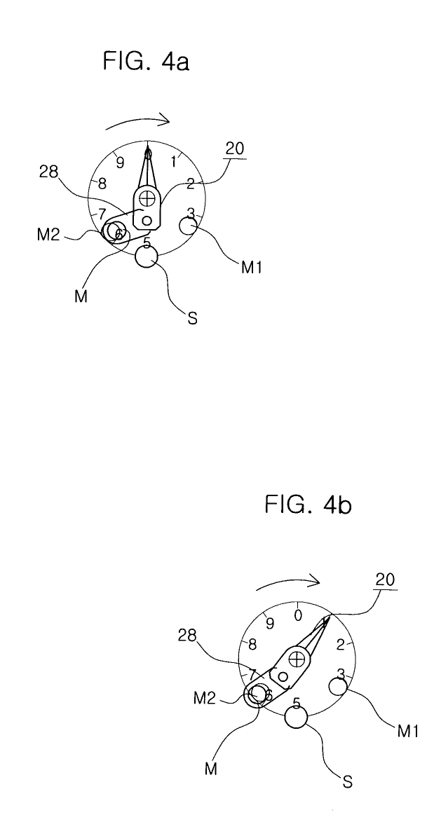

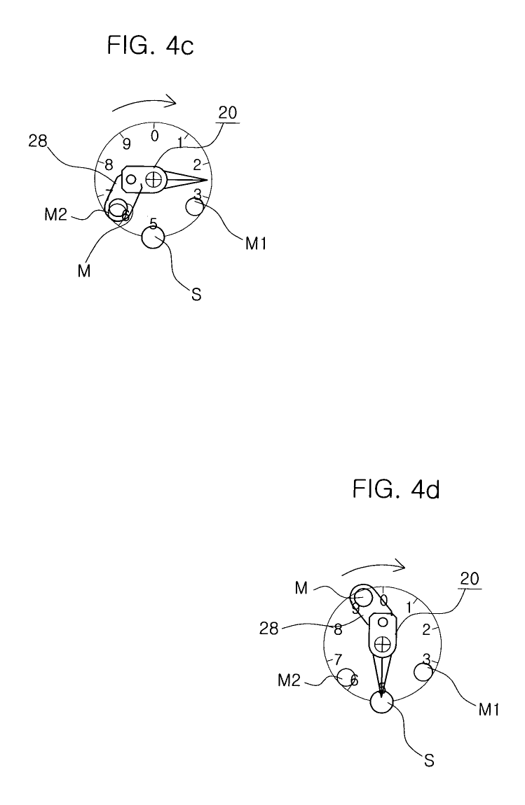

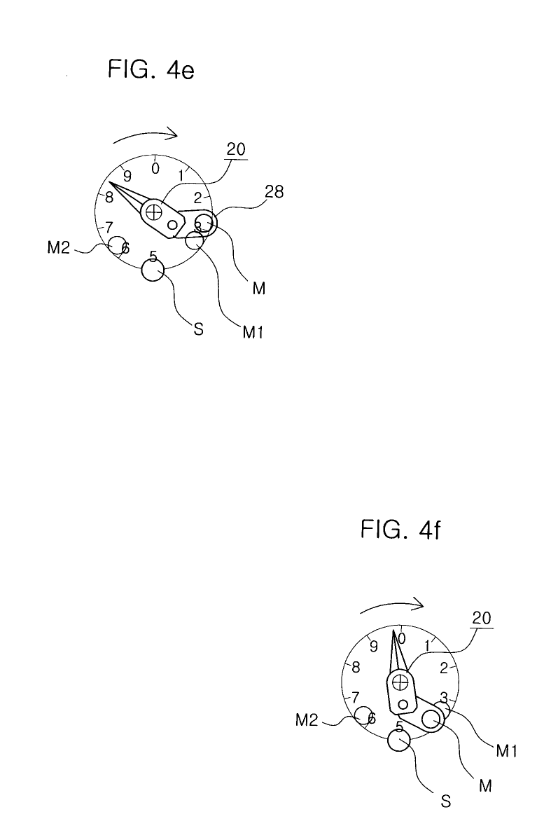

With reference to FIGS. 4a to 4f, the pointer needle 20 of the meter is rotated according to the amount of water consumption by a user. As described above, since the meter in which the pointer needle 20 is rotated one time per 0.1 liter of the amount of water consumption is used, the pointer needle 20 of the meter has a high rotational speed.

As shown in FIG. 4a, at the start of the rotation of the pointer needle 20, there is attractive force acting between the second magnet (M2) and the magnet (M) of the link shaft 28. Therefore, the link shaft 28 provided with the magnet (M) is attached to the second magnet (M2).

The attractive force between the second magnet (M2) and the magnet (M) is maintained until steps of FIGS. 4b and 4c. When the pointer needle 20 is further rotated, the pointer needle 20 is gradually rotated from the link shaft 28 until the link shaft 28 is restricted by the ridges 22a formed on both ends of the slot 22 of the pointer needle 20. Then, since the attractive force between the second magnet (M2) and the magnet (M) is eliminated by rotary force (external force) of the pointer needle 20, the magnet (M) of the link shaft 28 is detached from the second magnet (M2) and freely rotated within the dial plate (FIG. 4d).

As the pointer needle 20 is continuously rotated, the magnet (M) of the link shaft 28 enters into the sensing range of the reader switch (S) on the dial plate. Since the first magnet (M1) on the dial plate 12 has the same polarity as that of the magnet (M), there is repulsive force acting between the first magnet (M1) and the magnet (M).

That is, the repulsive force between the first magnet (M1) and the magnet (M) prevents the link shaft 28 connected to the end of the pointer needle 20 from entering into the sensing range of the reader switch (S) on the dial plate. Such a restriction is maintained until the link shaft 28 is restricted by the ridge 22a of the slot 22 of the pointer needle 20. When the link shaft 28 is restricted by the ridge 22a of the slot 22 of the pointer needle 20, the link shaft 28 jumps the first magnet (M1). After the link shaft 28 jumps the first magnet (M1), the link shaft 28 is suddenly rotated on the fixing pin 26 by the repulsive force between the first magnet (M1) and the magnet (M), and rapidly passes through the sensing range on the dial plate by the attractive force between the second magnet (M2) and the magnet (M).

Although the link shaft 28 rapidly passes through the sensing range of the reader switch (S), the reader switch (S) can sense the passing of the link shaft 28. The link shaft 28 rapidly passes through the sensing range regardless of the rotational speed of the pointer needle 20 (FIGS. e and f).

While the pointer needle 20 is rotated one time, the link shaft 28 passes through the sensing range of the reader switch (S) one time. Even though the pointer needle 20 is slowly rotated or stopped at any point on the dial plate 12, the magnet (M) on the end of the link shaft 28 is always located outside of the sensing range (a) of the reader switch (S).

Since power is consumed only at the sensing moment of the reader switch (S), the above-described meter of the present invention reduces power consumption rate. Further, since the magnet (M) of the link shaft 28 is always located outside of the sensing range (a) of the reader switch (S) even when the pointer needle 20 is stopped, the continuous operation of the reader switch (S) is prevented. Such a discontinuous operation maintains the power consumption rate for sensing the passing of the link shaft 28 by the reader switch (S) at approximately 10˜20 ^{μA}/hr, thereby allowing the meter to be used for a long time (approximately 10 years) without the replacement of its battery.

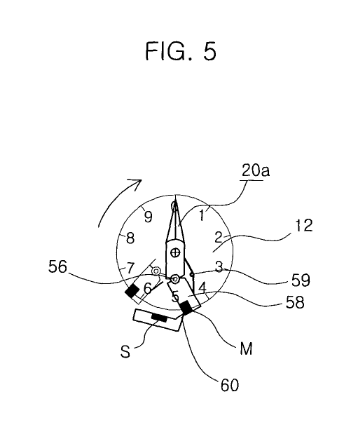

Hereinafter, with reference to FIG. 5, a meter in accordance with another embodiment of the present invention is described.

This embodiment is characterized in that a restriction part for temporarily restricting an entry of a link shaft 58 into the sensing range does not include a magnet, but includes a stopper 60. Activating force for triggering the link shaft 58 is accumulated by compression of a spring 59.

A link shaft 58 provided with the magnet (M) laid in its end is rotatably connected to a pointer needle 20a by a fixing pin 56. The elastic spring 59 is interposed between the pointer needle 20a and the link shaft 58 so that a straightly-aligned state of the pointer needle 20a and the link shaft 58 is elastically maintained. The elastic spring 59 provides an elastic force to the link shaft 58 to elastically return it to its straightly-aligned state with the pointer needle 20a. The reader switch (S) serving as a sensor is installed on a designated position on an external surface of the dial plate 12. The restriction part includes the stopper 60 installed prior to the start of the sensing range of the reader switch (S) so that the link shaft 58 is temporarily restricted by the stopper 60, and when the link shaft 58 goes over the stopper 60, the magnet (M) of the end of the link shaft 58 rapidly passes through the sensing range (a) of the reader switch (S) regardless of the rotational speed of the pointer reader 20a.

The operation and function of the ultra power-saving type meter of the aforementioned embodiment of the present invention are described, as follows. As described above, the link shaft 58 is restricted by the stopper 60 prior to the start of the sensing range of the reader switch (S). That is, the rotation of the link shaft 58 is restricted by the stopper 60 prior to the start of the sensing range of the reader switch (S). When the pointer needle 20 is rotated so as to reduce an angle with the link shaft 58 in the rotational direction centering on the fixing pin 56, restoring force is accumulated in the compressed spring 59. When the pointer needle 20a is further rotated, the angle between the pointer needle 20a and the link shaft 58 is further reduced. When the angle between the pointer needle 20a and the link shaft 58 reaches the minimum value, the link shaft 58 pivots away from the pointer needle 20a by means of the pressure accumulated on the spring 59 and simultaneously the magnet (M) on the end of the link shaft 58 elastically passes through the sensing range of the reader switch (S). Thereby, the reader switch (S) senses the measured value of the meter.

In this embodiment, as described above, even when the pointer needle 20a is stopped or is slowly rotated, the link shaft 58 is located outside of the sensing range (a) of the reader switch (S). The link shaft 58 passes through the sensing range of the reader switch (S) by the pressure accumulated on the compressed spring 59, thereby allowing the reader switch (S) to sense the passing of the link shaft 58.

Thereby, the power consumption required to operate the reader switch is reduced, and occurrence of malfunctions in the sensing step of the reader switch is decreased.

A non-described reference character T denotes a controller. The controller counts the times the digital signal is sensed by the reader switch (S), and transmits the counted times to the relevant agency, thereby performing a remote transmission system.

Industrial Applicability

As apparent from the above description, the present invention provides an ultra power-saving type meter for converting a measured value into a digital signal, being additionally combined with a conventional analog meter. The meter of the present invention comprises a link member including a link shaft and a magnet, which rapidly passes through a sensing range of a reader switch for recognizing one rotation of a pointer needle of the meter as a digital signal regardless of the rotational speed of the pointer needle.

Since power is consumed only during the short sensing time of the reader switch, the power consumption rate is remarkably reduced. Therefore, the meter of the present invention can be continuously used for a long period of time of approximately 10 years. Further, the meter of the present invention does not require a separate wiring for its power supply, and is easily combined with a meter laid underground.

Since the magnet on the link shaft rapidly passes through the sensing range of the reader switch regardless of the rotational speed of the pointer needle, the meter of the present invention prevents error or malfunction in the sensing step of the reader switch. Further, since the magnet on the link shaft is always located outside of the sensing range, the meter of the present invention reduces the power consumption due to the discontinuous operation of the reader switch and prevents error and malfunction of its circuitry.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An ultra power-saving type meter for converting a measured value into a digital signal, comprising:
a link member (L) provided with a magnet (M), and hinged to a pointer needle of the meter rotating according to the amount of consumption of a flow so as to be eccentric from a central axis of rotation the pointer needle;
a reader switch (S) serving as a sensor for recognizing one rotation of the pointer needle as a digital signal by means of the magnet of the link member; and
a restriction part (h) for temporarily restricting an entry of the link member (L) into a sensing range (a) of the reader switch and then suddenly triggering the link member (L), being located on a designated position outside of the sensing range of the reader switch,
wherein the magnet (M) of the link member (L) rapidly passes through the sensing range (a) of the reader switch regardless of a rotational speed of the pointer needle of the meter.

2. The ultra power-saving type meter for converting a measured value into a digital signal as set forth in claim 1,
wherein a needle part (10) includes:
the rotatable pointer needle including:
one pointed end and the other end being opposite to the pointed end;
a slot (22) formed through the other end so that a link shaft 28 of the link member (L) provided with the magnet (M) laid in its end is rotatably connected to the slot (22) by a fixing pin (26); and
a pin hole (24) formed through the slot (22); and
a dial plate (12) provided with a measuring scale;
wherein the restriction part includes:
a first magnet (M1) attached on the dial plate at a designated position prior to the start of the sensing range, having the same polarity as that of the magnet (M) of the link shaft (28), on their facing surfaces; and
a second magnet (M2) attached on the dial plate at another designated position after the end of the sensing range, having the reverse polarity of the magnet (M) of the link shaft (28), on their facing surfaces; and
wherein the reader switch (S) for recognizing the passing of the magnet (M) of the link shaft (28) as a digital signal is located at an approximately central position between the first and second magnets (M1 and M2) formed on the dial plate (12).

3. The ultra power-saving type meter for converting a measured value into a digital signal as set forth in claim 2, wherein the position of each of the first and second magnets (M1 and M2) interacting with the magnet (M) of the link shaft (28) is located outside of the sensing range of the reader switch (S) on the dial plate.

4. The ultra power-saving type meter for converting a measured value into a digital signal as set forth in claim 1, further comprising an elastic spring (59) interposed between the pointer needle (22a) and a link shaft (58) rotatably connected to the pointer needle (22a) by a fixing pin (56) so as to provide an elastic force to the link shaft (58) to elastically maintain a straightly-aligned state of the pointer needle and the link shaft (58),
wherein the reader switch (S) is installed on a designated position on an external surface of the dial plate (12), and the restriction part includes a stopper (60) installed prior to the start of the sensing range of the reader switch so that the link shaft (58) is temporarily restricted by the stopper (60), and when the link shaft (58) passes over the stopper (60), the magnet of the end of the link shaft (58) rapidly passes through the sensing range of the reader switch regardless of a rotational speed of the pointer reader.
